(19) United States
(12) Patent Application Publication
(10) Pub. No.: US 2009/0122157 A1
(43) Pub. Date: May 14, 2009

(54) INFORMATION PROCESSING APPARATUS, INFORMATION PROCESSING METHOD, AND COMPUTER-READABLE STORAGE MEDIUM

(75) Inventors: Hideo Kuboyama, Yokohama-shi (JP); Toshiaki Fukada, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/264,826

(22) Filed: Nov. 4, 2008

(30) Foreign Application Priority Data
Nov. 14, 2007 (JP) 2007-295593
Sep. 5, 2008 (JP) 2008-228324

(51) Int. Cl. H04N 5/76; G10L 17/00

(52) U.S. Cl. 348/231.4; 704/246

(57) ABSTRACT

An information processing apparatus configured to attach sound information to image data while relating the sound information to the image data includes a display control unit configured to cause a display unit to display an image represented by the image data, an acquisition unit configured to acquire sound information while the display unit is displaying the image, a detection unit configured to detect whether a speech is included in the sound information acquired by the acquisition unit, and a storage unit configured to store the sound information while relating the sound information to the image data if the detection unit detects a speech included in the sound information.

### BACKGROUND OF THE INVENTION

1. Field of the Invention

The present invention relates to a technique for relating sound information to image data in synchronization with displaying an image represented by the image data on, e.g., a display unit of a digital camera.

2. Description of the Related Art

With recent digitalization of information, digitalized information increases. Thus, it is important how to manage digitalized information. More specifically, it is important how to classify and search image data representing a large number of images captured by, e.g., digital cameras when the image data is stored in a personal computer (PC).

It is known as a general method for facilitating the classification and search to attach metadata to the image data and to perform the classification and search based on the attached metadata.

A method for automatically attaching data representing, e.g., a photographing date, the name of a camera, and a photographing condition to the image data as metadata is widely performed as that for attaching metadata to image data.

However, metadata to be attached to image data covers a wide range of information. Accordingly, it is difficult for a camera to automatically attach information representing, e.g. a photographing object, a place, and an event to image data as metadata without a user's input of the information. Therefore, in order to assist a user of the camera to select and input metadata, candidates for the metadata can be indicated to the user via a graphical user interface (GUI). Alternatively, sound information corresponding to metadata can be recorded.

A voice memo function for recording sound information to be attached to image data is widely used in digital cameras. With the voice memo function, users can record information concerning image data with their own voices, and also record environmental sound corresponding to image data. In addition, a recorded voice memo can be converted into metadata representing text by performing speech recognition of the voice memo.

However, it is time-consuming to activate the voice memo function in a system menu each time need arises. Thus, a function of simply attaching a voice memo to image data without users' troubles is demanded. Several patent literatures written in the context of such a demand are known.

For example, Japanese Patent Application Laid-Open No. 2002-057930 discusses a digital camera that acquires, when a user pushes a shutter button, a speech in an audio recording mode in response to the push of the shutter button. Japanese Patent Application Laid-Open No. 2003-069925 discusses a digital camera that acquires a speech within a time period from a half-push or full-push of a shutter button to a release of the shutter button.

However, it applies a heavy load to a user to simultaneously attach, when a user pushes the shutter button while focusing attention to a photographing object, a voice memo to image data. It can be desired for a user that a voice memo to be related to image data is attached thereto when the user visually checks the image data.

In addition, because each of the digital cameras discussed in the patent literatures acquires a voice memo in synchronization with a shutter operation, useless audio files may be stored in a memory when a user does not attach a voice memo to image data.

### SUMMARY OF THE INVENTION

The present invention is directed to an information processing apparatus, such as a digital camera, which efficiently acquires sound information in synchronization with displaying an image in a display unit thereof and attaches the obtained sound information to image data corresponding to the image.

According to an aspect of the present invention, an information processing apparatus configured to attach sound information to image data while relating the sound information to the image data includes a display control unit configured to cause a display unit to display an image represented by the image data, an acquisition unit configured to acquire sound information while the display unit is displaying the image, a detection unit configured to detect whether a speech is included in the sound information acquired by the acquisition unit, and a storage unit configured to store the sound information while relating the sound information to the image data if the detection unit detects a speech included in the sound information.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a hardware configuration of an information processing apparatus according to a first exemplary embodiment of the present invention.

FIG. 2 is a block diagram illustrating a functional configuration of the information processing apparatus according to the first exemplary embodiment of the present invention.

FIG. 3 is a flowchart illustrating a process flow according to the first exemplary embodiment of the present invention.

FIG. 4 illustrates an example of use as a digital camera according to the first exemplary embodiment of the present invention.

FIG. 5 illustrates an example of use as a copying machine according to a second exemplary embodiment of the present invention.

FIG. 6 illustrates an example of use as image viewing software according to the second exemplary embodiment of the present invention.

FIG. 7 is a block diagram illustrating a functional configuration of an information processing apparatus according to a third exemplary embodiment of the present invention.

FIG. 8 is a flowchart illustrating a process flow according to a fourth exemplary embodiment of the present invention.

FIG. 9 is a time chart illustrating a data display operation and a sound information acquisition operation according to the fourth exemplary embodiment of the present invention in a case where sound information includes no speech.

FIG. 10 is a time chart illustrating a data display operation and a sound information acquisition operation according to the fourth embodiment of the present invention in a case where sound information includes speech.

FIG. 11 is a block diagram illustrating a functional configuration of an information processing apparatus according to a seventh exemplary embodiment of the present invention.

FIG. 12 is a flowchart illustrating an image display operation according to a ninth exemplary embodiment of the present invention.

FIG. 13 is a flowchart illustrating a sound information acquisition operation according to the ninth exemplary embodiment of the present invention.

FIG. 14 illustrates timings of displaying a plurality of images, those of detecting speeches, and those of storing sound information according to the ninth exemplary embodiment of the present invention in a case where a time period of acquisition of sound information (i.e., detection of a speech) corresponding to one image does not fall within a time period in which the one image is displayed.

FIG. 15 illustrates timings of displaying a plurality of images, those of detecting speeches, and those of storing sound information according to the ninth exemplary embodiment of the present invention.

FIG. 16 illustrates timings of displaying a plurality of images, those of detecting speeches, and those of storing sound information according to the ninth exemplary embodiment of the present invention in a case where a time period of detection of a speech corresponding to one image exceeds and further continues from a time at which a preset time period has elapsed since the finish of display of the one image.

FIG. 17 illustrates timings of displaying a plurality of images, those of detecting speeches, and those of storing sound information according to the ninth exemplary embodiment of the present invention in a case where a duration of a speech detected in a time period, in which one image is displayed, exceeds a time period, in which another image is displayed, and further continues to a time period in which still another image is displayed.

FIG. 18 is a flowchart illustrating a modification of the sound information acquisition operation according to the ninth exemplary embodiment of the present invention

FIG. 19 illustrates timings of displaying a plurality of images, those of detecting speeches, those of storing sound information, and change in a threshold value for detecting a speech according to the ninth exemplary embodiment of the present invention.

### DETAILED DESCRIPTION OF THE EMBODIMENTS

Various exemplary embodiments, features, and aspects of the invention will be described in detail below with reference to the drawings.

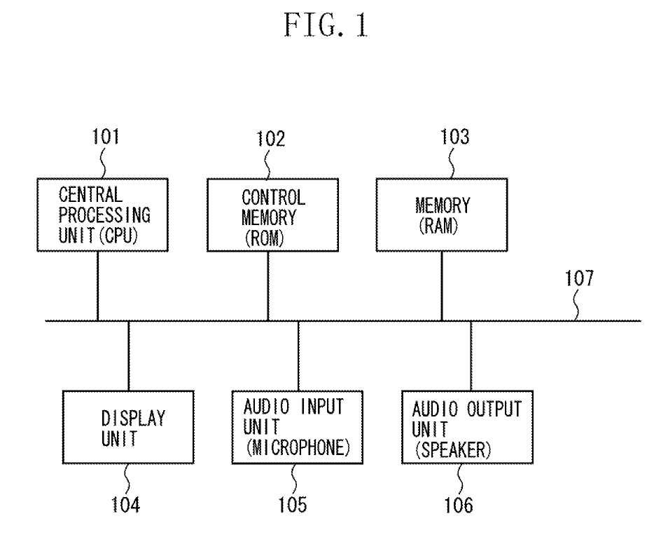

FIG. 1 illustrates a hardware configuration of an information processing apparatus according to a first exemplary embodiment of the present invention. The information processing apparatus includes a central processing unit (CPU) 101, a control memory having a read-only memory (ROM) 102, and a memory 103 having a random access memory (RAM) 103.

The information processing apparatus further includes a display unit, such as a liquid crystal display unit, 104, an audio input unit, such as a microphone, 105, and an audio output unit, such as a speaker, 106.

The information processing apparatus further includes a data bus 107 via which signals are transmitted among the above-described components thereof. The information processing apparatus including the above-described components is, e.g., a digital camera.

Accordingly, the information processing apparatus includes an imaging device, such as a scanner or a charge-coupled device (CCD), (not shown in FIG. 1). The information processing apparatus has a function of causing the display unit 104 to display an image (image data) captured by the imaging device.

Further, an image represented by image data, which is acquired by the imaging device, is compression-coded using a compression coding program stored in the CPU 101 and the memory 102 according to formats, such as Joint Photographic Experts Group (JPEG) format, JPEG2000 format, and Joint Photographic Experts Group Extended Range (JPEG-XR) format.

Moreover, compression-coded image data (i.e., coded data corresponding to one picture) is stored as a file in the memory 103, together with sound information, e.g., a voice memo, according to various methods which will be described below.

As described above, a control program for implementing information processing according to the present embodiment and data usable by the control program are recorded in the ROM 102.

The control program and the control data are properly fetched into the RAM 103 under the control of the CPU 101 via the data bus 107. The control program is executed by the CPU 101. That is, when the present embodiment is implemented using the information processing apparatus illustrated in FIG. 1, software processing is executed.

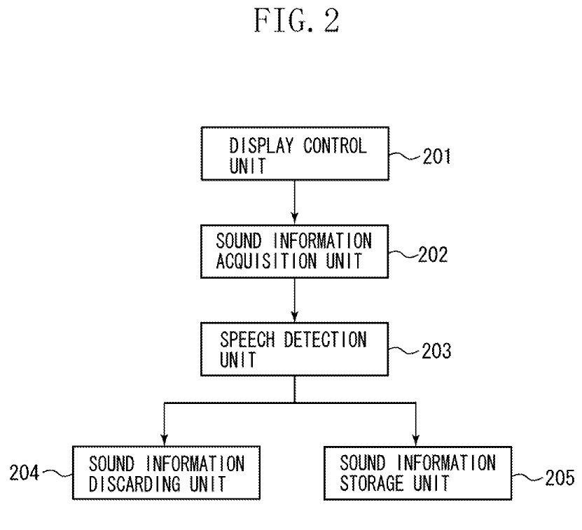

FIG. 2 illustrates a functional configuration of the information processing apparatus according to the first exemplary embodiment of the present invention. The information processing apparatus includes a display control unit 201 for causing the display unit 104 to display an image (picture) corresponding to image data acquired by the imaging device.

This image data is utilized to display an associated image just after the image is captured by the imaging device. In addition, the image data is used as an object of compression coding. Compression-coded image data is stored in a memory (not shown in FIG. 2), which corresponds to the memory 103 illustrated in FIG. 1.

Such compression-coded image data is stored in the memory 103, together with sound information, according to various methods which will be described below. A sound information acquisition unit 202 acquires sound information via the audio input unit 105 in synchronization with displaying of an image, which is controlled by the display control unit 201.

A speech detection unit 203, into which sound information acquired by the sound information acquisition unit 202 is input, detects a speech (a meaningful sound intentionally uttered by a person) included in the sound information.

A sound information discarding unit 204 discards sound information. A sound information storage unit 205 stores sound information.

Incidentally, the sound information storage unit 205 can be considered to constitute a part or all of the memory 103 illustrated in FIG. 1. In this case, the aforementioned compression-coded image data can be considered to be stored in the sound information storage unit 205.

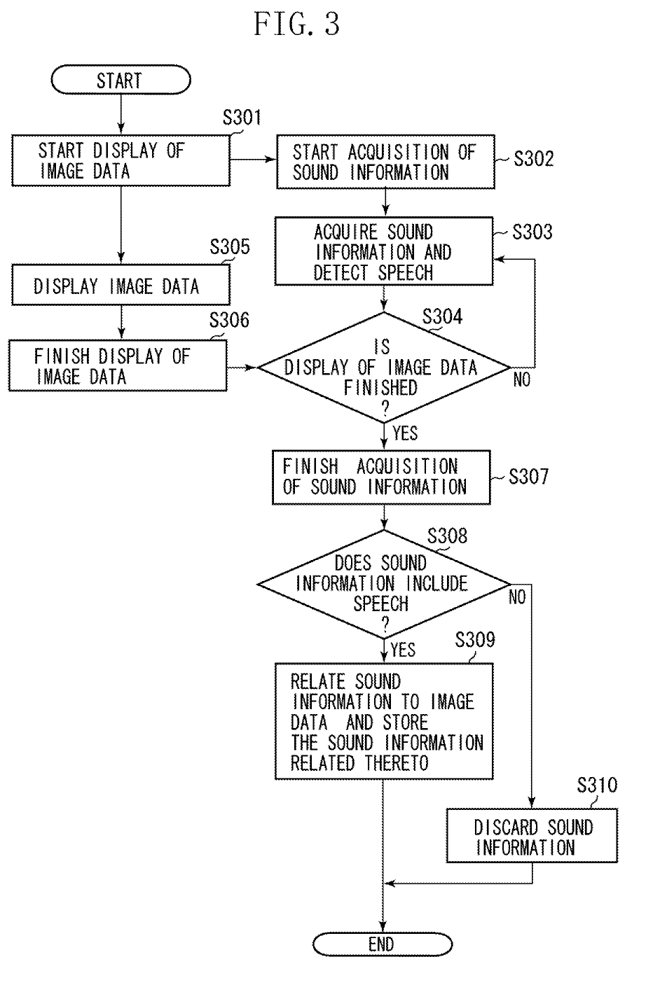

FIG. 3 is a process flow illustrating an operation of the information processing apparatus according to the first exemplary embodiment of the present invention. A sound information acquisition process according to the present embodiment is described below by referring to FIGS. 2 and 3.

First, in step S301, the display control unit 201 causes the display unit 104 to start displaying an image represented by image data. In step S302, the sound information acquisition unit 202 starts acquiring sound information in synchronization with the start of displaying the image.

This sound information includes, e.g., a sound uttered by a user of the information processing apparatus (i.e., a person) as a voice memo. In step S303, sound information acquired during displaying of the image data is input to the speech detection unit 203, which detects the presence/absence of a speech in the input sound information.

In step S304, the sound information acquisition unit 202 checks whether the display of the image data is finished. If the display of the image data is not finished (NO in step S304), the process returns to step S303. Then, the sound information acquisition unit 202 continues to acquire sound information. If the display of the image data is finished (YES in step S304), the process proceeds to step S307.

In step S305, the display control unit 201 causes the display unit 104 to display the image data. In step S306, the display control unit 201 causes the display unit 104 to stop displaying the image data.

In step S307, the sound information acquisition unit 202 finishes the acquisition of sound information. Then, in step S308, the speech detection unit 203 checks whether it is detected in step S303 that the sound information includes a speech.

If it is determined that the sound information includes a speech (YES in step S308), the process proceeds to step S309. In step S309, the sound information storage unit 205 stores the sound information while relating the sound information to image data, which corresponds to the displayed image and is converted according to JPEG format, JPEG2000 format, or JPEG-XR format.

At that time, sound information to be stored can be all of the sound information acquired in synchronization with the display of the image within a time period from the start of the display of the image to the finish of the display thereof. The sound information storage unit 205 can store only sound information corresponding to a speech period determined by the speech detection unit 203 to include a speech.

Further, in a case where the sound information includes speech information which is present in each of a plurality of speech periods, one sound information file can be made by connecting a plurality of pieces of sound information, which respectively correspond to the plurality of speech periods. Alternatively, a plurality of sound information files can be made, which respectively correspond to the plurality of speech periods.

On the other hand, if it is determined that the sound information includes no speech (NO in step S308), the process proceeds to step S310. In step S310, the sound information discarding unit 204 discards the sound information.

Incidentally, a speech detected by the speech detection unit 203 from sound information is a voice (word) uttered by a person. The speech detection unit 203 can apply various methods, such as a method based on power of a sound signal representing sound information, a method based on the number of times of zero-crossing of a waveform of a sound signal, and a method based on pitch information or frequency characteristics, to the detection of a speech.

Further, for example, a method for storing image data and sound information as files, whose names differ from each other only in extension thereof (e.g., a combination of file names “AAA.JPG” and “AAA.WAV”), and a method of describing the file name of a file of sound information in a part of a header of image data as link information, can be employed as a method for relating sound information to image data.

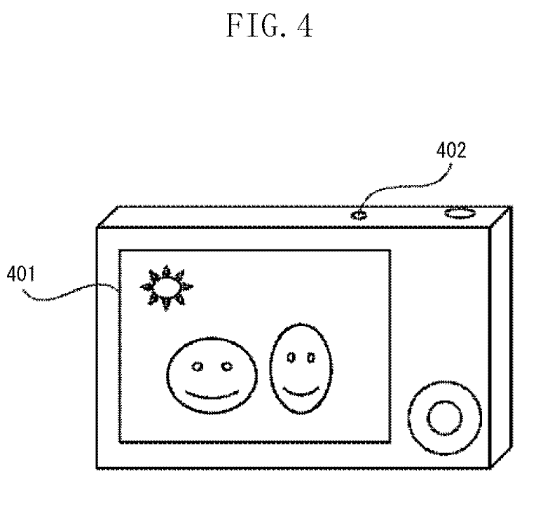

FIG. 4 illustrates an example of application of the present invention to the display for checking an image (captured image) in a digital camera (corresponding to the apparatus illustrated in FIG. 1) according to the first exemplary embodiment of the present invention.

The digital camera illustrated in FIG. 4 includes a display unit 401 (corresponding to the display unit 104 illustrated in FIG. 1) and a microphone 402 (corresponding to the audio input apparatus 105 illustrated in FIG. 1) for inputting sound information.

The display for checking the captured image in the digital camera is what is called “previewing”, by which the captured image is displayed on the display unit 401 for a predetermined time period in order to enable checking the captured image.

Incidentally, in the following description of the present embodiment, it is assumed that an image (i.e., what is called a preview) is displayed mainly just after the image is captured. However, the display for checking a captured image according to the present embodiment is not limited to that performed immediately after the image is captured.

The present invention can be applied to a case where image data representing an image captured in a past time is stored in a memory and is reproduced in, e.g., a slide show.

In the present embodiment, sound information is automatically acquired by the microphone 402 within a time period from the start of display of an image to the finish of the display thereof (i.e., a time period during which one captured image is displayed on the display unit 401).

If sound information includes a speech, the speech is detected by the speech detection unit 203. In addition, the sound information storage unit 205 stores the sound information in the memory as a voice memo while relating the sound information to the image.

On the other hand, if the sound information includes no speech, the sound information is determined as an unnecessary memo and is discarded by the sound information discarding unit 204. Consequently, only sound information generated by a user (i.e., a voice uttered by a user) at the display of the image is related to the image as a voice memo and is stored in the memory.

As described above, a user can easily attach a voice memo to image data representing an image (or photograph) while checking the image.

In addition, only a voice memo spoken by the user can be stored while automatically relating the voice memo to image data.

Although an example of attaching, after an image is captured by a digital camera, a voice memo to image data while the captured image is checked has been described in the above-described embodiment, the present invention is not limited thereto.

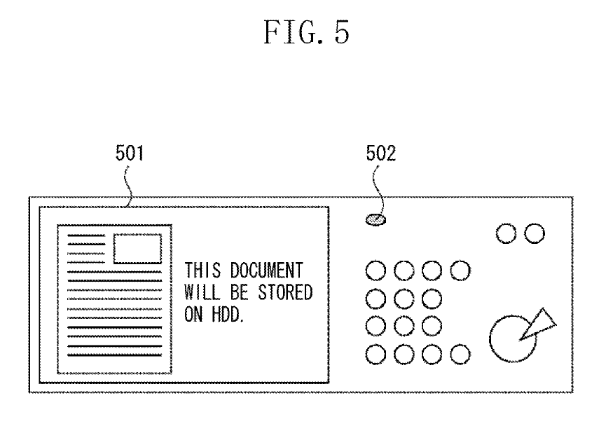

FIG. 5 illustrates a display screen and a control panel of a copying machine according to a second exemplary embodiment of the present invention to describe an example of attaching a voice memo to image data representing a scanned document in the copying machine while the scanned document is checked.

As illustrated in FIG. 5, the copying machine includes a display unit 501 for displaying information, and a microphone 502 for inputting sound information. When a user causes the copying machine to scan a document, an image of the scanned document (represented by image data) is displayed on the display unit 501 to enable checking the scanned document.

Further, the image data representing the scanned document is stored in a hard disk in the copying machine in synchronization with the display of the scanned document (represented by the image data). The document represented by the image data stored in the hard disk is subsequently copied (i.e., printed by a print unit (not shown) in the copying machine) or is sent by a facsimile to an external apparatus.

In the present embodiment, sound information is automatically acquired by the microphone 502 in synchronization with the start of display of the document for checking.

At that time, in a case where a user utters a speech, the sound information (the speech) is related to the above-described document (represented by the image data) as a voice memo and is stored in the hard disk. On the other hand, in a case where a user does not utter a speech, the sound information is discarded. Thus, no voice memo is attached to the above-described document.

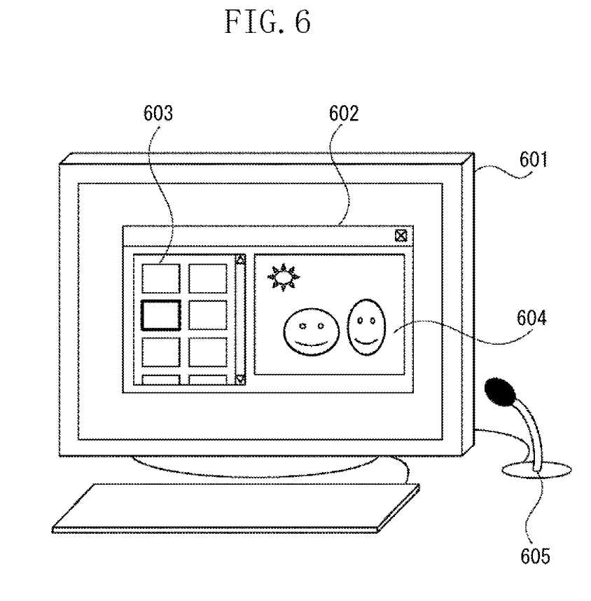

FIG. 6 illustrates an example of attaching a voice memo to image data representing an image displayed by image viewing software. As illustrated in FIG. 6, a window 602 is displayed by the image viewing software, which runs on a computer 601.

An image list 603 for listing images is displayed in the window 602 by the image viewing software. An image to be processed is enlargedly displayed in an image display area 604. A microphone 605 for inputting sound information is connected to the computer 601.

When a user selects one of the images from the image list 603, or when a user causes the image viewing software to perform a function of performing “an operation of sequentially changing and displaying a plurality of images”, one of the images, which is currently selected by the user, is displayed in the image display area 604 in an enlarged state.

Then, the acquisition of sound information via the microphone 605 is started in synchronization with the start of display of each image. When the display of each image is automatically or manually finished, the acquisition of sound information is finished in synchronization therewith.

In the case of the “operation of sequentially changing and displaying a plurality of images”, when the display of an image is finished, the next image is displayed in synchronization with the finish of the display of the currently displayed image. Accordingly, the acquisition of sound information is started again. In addition, according to a determination by the speech detection unit 203, the sound information acquired corresponding to each image is stored, in a case where the acquired sound information includes a speech, while relating the acquired sound information to the displayed image. However, in a case where the acquired sound information includes no speech, the acquired sound information is discarded.

In the above-described second embodiment, the second detection unit 203 determines whether sound information includes a speech of a person. In a case where the sound information includes a speech, the sound information is related to image data and is then stored. On the other hand, in a case where the sound information includes no speech, the sound information is discarded. That is, the above-described embodiments take into consideration whether “the sound information includes a speech”. However, the above-described embodiments take into consideration “what meaning the speech included in the sound information has”. Therefore, a third exemplary embodiment of the present invention has a function of relating an acquired speech to image data and storing the acquired speech only in a case where the acquired speech is included in specific recognition candidates, and discarding the acquired speech in a case where the acquired speech is included in the specific recognition candidates, in addition to the functions of the above-described first and second embodiments.

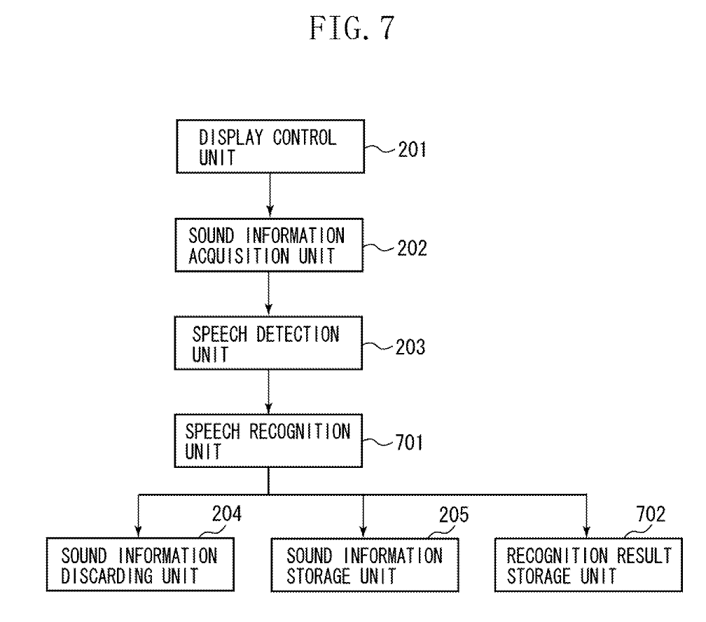

FIG. 7 is a block diagram illustrating a functional configuration of an information processing apparatus according to the third exemplary embodiment of the present invention. Each of units 201 through 205 has a function equivalent to that of an associated one of the units of each of the first and second exemplary embodiments.

The speech detection unit 203 determines whether sound information acquired in synchronization with the display of an image represented by image data includes a speech. Sound information determined to include no speech is discarded by the sound information discarding unit 204. On the other hand, sound information determined to include a speech is input to a speech recognition unit 701.

The speech recognition unit 701 recognizes a speech and determines whether the acquired speech is one of the specific recognition candidates, and whether the acquired speech is discarded because the acquired speech is not any of the specific recognition candidates.

If the acquired speech is one of the specific recognition candidates, the sound information including the speech is stored in the sound information storage unit 205. In addition, a result of speech recognition (i.e., text data or an identification flag) is stored in a recognition result storage unit 702.

Incidentally, the third exemplary embodiment is similar to other exemplary embodiments in that the sound information to be stored in the storage unit 205 and a result of the speech recognition to be stored in the sound information storage unit 702 are stored while being related to image data representing an image currently displayed on the display unit.

It is now considered, e.g., a case where image data corresponding to the file “AAA.JPG” is displayed, and where a word “restaurant” is obtained as the result of the speech recognition. In this case, the word “restaurant” is stored while being related to the image data “AAA.JPG” as text data (or an identification flag) “AAA.TXT”

In addition, sound information (including the word “restaurant”), which is acquired while the image data corresponding to the file “AAA.JPG” is displayed, is stored as the file “AAA.WAV”.

However, in a case where the speech recognition unit 701 determines that the acquired speech does not match any of the specific recognition candidates, and where the speech recognition unit 701 outputs no recognition result, the sound information is discarded by the sound information discarding unit 204.

Hidden Markov model (HMM), dynamic programming (DP) matching algorithm, and a neural network can be applied to a speech recognition method. The specific recognition candidates, which can be recognized by the speech recognition unit 701, are, e.g., a word sequence preliminarily prepared by the apparatus or a word sequence registered in the apparatus by a user.

Thus, a user can relate text data representing the content of a voice memo to currently displayed image data and attach the text data to the image data, together with the voice memo, without performing a cumbersome operation. Further, in a case where a user utters no speech, and where a user utters a language that cannot be accepted by the speech recognition unit 701, the voice memo can be automatically discarded.

In the above-described first exemplary embodiment, it has been described that processing is changed from the display of image data in step S305 to the finish of the display of image data in step S306, in response to the elapse of a predetermined time period or to a user's operation.

On the other hand, according to a fourth exemplary embodiment of the present invention, in a case where a speech is detected in sound information, the display of image data, to which the speech is attached, is not finished until a speech period is terminated.

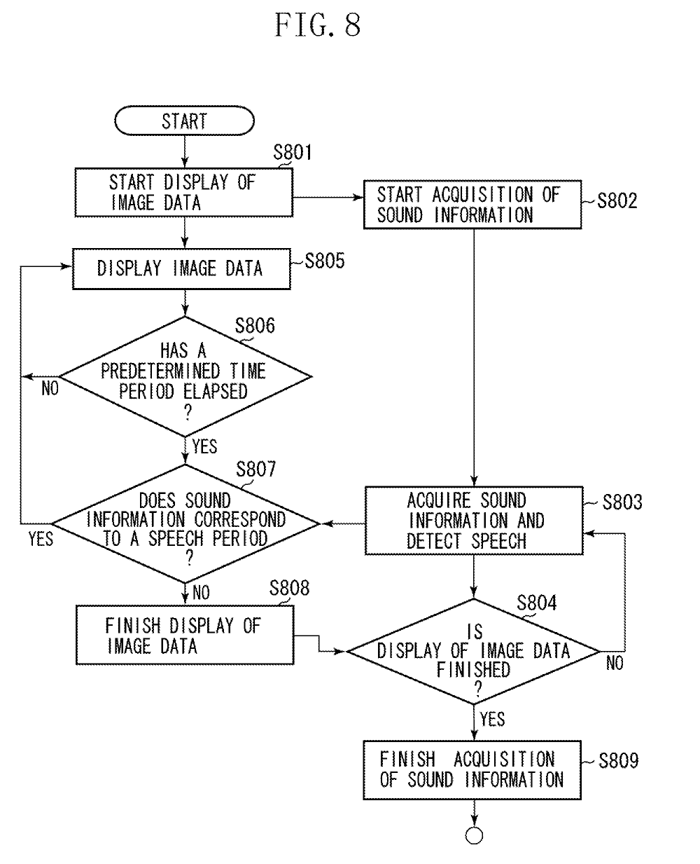

FIG. 8 illustrates a process flow of a process from the start of display of image data and acquisition of a speech to the finish thereof according to the fourth exemplary embodiment of the present invention. In step S801, the display control unit 201 causes the display unit to start displaying the image data. Then, in step S802, the sound information acquisition unit 202 starts acquiring sound information. In step S803, the sound information acquisition unit 202 acquires pieces of sound information serially. In addition, the speech detection unit 203 detects whether the sound information includes a speech.

The sound information acquisition unit 202 continues to acquire sound information until the finish of the display of the image data is confirmed in step S804. On the other hand, in step S805, the display control unit 201 causes the display unit 104 to display the image data. In step S806, the display control unit 201 checks whether a predetermined time period has elapsed since the start of the display of the image data.

Incidentally, the “predetermined time period” corresponds to a time period preliminarily set to have a length sufficient to the extent that the display (i.e., previewing) of one image is performed. If the predetermined time period has not elapsed (NO in step S806), the process returns to step S805, in which the display control unit 201 causes the display unit 104 to continue to display the image data. If the predetermined time period has elapsed (YES in step S806), the process proceeds to step S807.

In step S807, the speech detection unit 203 checks whether sound information input to the speech detection unit 203 corresponds to a speech period including a speech. If the sound information corresponds to such a speech period (i.e., a user is uttering a sequence of speeches) (YES in step S807), the process returns to step S805, in which the display control unit 201 causes the display unit 104 to continue to display the image data. If the sound information does not correspond to a speech period (NO in step S807), the process proceeds to step S808. In step S808, the display control unit 201 finishes the display of the image data.

If the display control unit 201 causes the display unit 104 to finish the display of the image data (YES in step S804), the process proceeds to step S809. In step S809, the sound information acquisition unit 202 finishes the acquisition of sound information.

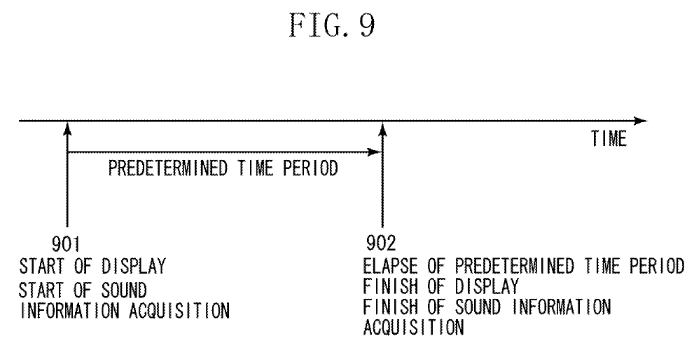

FIG. 9 illustrates a time period in which image data is displayed, according to the fourth embodiment of the present invention, in a case where sound information includes no speech. First, at time point 901, the display control unit 201 causes the display unit 104 to start displaying image data. The sound information acquisition unit 202 starts the acquisition of sound information in synchronization with the start of display of the image data.

The acquired pieces of sound information are serially input to the speech detection unit 203. Then, the speech detection unit 203 determines whether the sound information includes a speech. As illustrated in FIG. 9, a predetermined time period elapses in a state in which no speech is detected from the sound information.

Thus, in this case, the display control unit 201 causes the display unit 104 to finish the display of the image data at time point 902, at which the predetermined time period has elapsed. In addition, the sound information acquisition unit 202 finishes the acquisition of sound information.

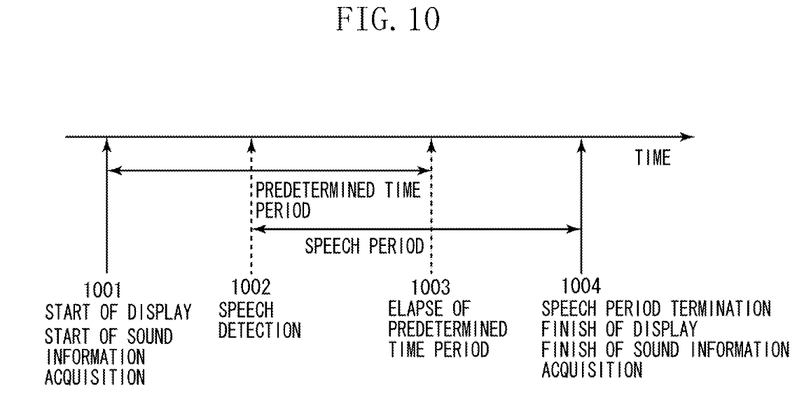

FIG. 10 illustrates a time period in which image data is displayed, according to the fourth embodiment of the present invention, in a case where sound information includes a speech. First, at time point 1001, the display of the image data and the acquisition of the sound information are started. At time point 1002, the speech detection unit 203 detects a speech.

During a period in which a user utters a speech, the speech is continued to be detected in terms of a speech period. At time point 1003, the predetermined time period elapses, similarly to the case illustrated in FIG. 9. However, because a speech is still detected, the display of the image data is not finished (YES in step S807).

In a case where a speech becomes undetected at time point 1004, the speech detection unit 203 transmits the termination of a speech period to the display control unit 201 (corresponding to NO in step S807). The display control unit 201 finishes the display of the image data in response to the transmission of the termination of a speech period. In addition, the sound information acquisition unit 202 finishes the acquisition of sound information.

Incidentally, even in a case where the termination of a speech period occurs earlier than the elapse of the predetermined time period, the display of the associated image data and the acquisition of sound information can be continued. On the other hand, at a time point at which a speech period is terminated, the display of the associated image data and the acquisition of sound information can be finished. In this case, the attachment of voice memos to a plurality of image data can be performed at high speed.

Thus, a user can appropriately attach a voice memo to image data without concern for a time period in which an image is displayed and a time period in which a speech is acquired, by extending a time period for each of the display of an image and the acquisition of sound information according to a speech period detected by the speech detection unit 203.

In the above-described fourth exemplary embodiment, a time period for each of the display of an image and the acquisition of sound information is extended while a speech period is detected. On the other hand, a time period for each of the display of an image and the acquisition of sound information can be extended according to a value output from a tilt sensor for detecting the tilt of the apparatus.

Sometimes, a user intentionally tilts the microphone in a desired direction to input sound information or tilts the display screen of the display unit 401 in a desired direction to check data. Thus, according to a fifth exemplary embodiment of the present invention, a tilt sensor capable of detecting the tilt of the digital camera illustrated in FIG. 4 is mounted in the digital camera.

Even in the present embodiment, the acquisition of sound information is started in synchronization with the start of display of an image. However, even after a predetermined time period has elapsed, the display of an image is not finished while the tilt sensor detects that the display screen is inclined at a predetermined tilt.

Then, the display of the image is finished at a time point at which the tilt sensor comes not to detect that the display screen is inclined at the predetermined tilt. The acquisition of sound information is finished in response to the finish of the display.

In the above-described exemplary embodiments, the speech detection unit 203 detects a speech included in sound information. Based on a result of determining whether sound information includes a speech, it is determined whether the speech is stored while being related to image data or is discarded.

A sixth exemplary embodiment of the present invention is not provided with the sound information discarding unit 204. It is described below a case where sound information is not discarded.

For example, in a case where a speech is detected based on a result of the determination made by the speech detection unit 203, sound information is related to image data representing a currently displayed image by describing sound information in a header portion of the image data. Then, the sound information is stored.

On the other hand, in a case where no speech is detected from sound information, the apparatus can be implemented such that the sound information is stored not without being related to the image data representing an image that is currently displayed. That is, advantages similar to those of the above-described exemplary embodiments can be obtained only by controlling the apparatus such that sound information is not linked with the currently displayed image.

Incidentally, the sound information to be stored while being related to the image data can be changed according to a result of determination of the presence/absence of a speech included in sound information. For example, the apparatus can be configured in the following manner. That is, in a case where it is detected that a speech is included in sound information, only sound information input within a time period corresponding to an associated speech period is stored. In a case where no speech is detected from sound information, all sound information acquired within a time period in which the image is displayed is stored.

In the above-described exemplary embodiments, the speech detection unit 203 detects a speech included in sound information. Based on a result of determining whether sound information includes a speech, it is determined whether the speech is stored while being related to image data or is discarded.

On the other hand, according to a seventh exemplary embodiment of the present invention, sound information is preliminarily classified into groups respectively corresponding to a plurality of types of sounds. According to the group into which the acquired sound information is classified, it is determined whether the sound information is stored or discarded. That is, the sound information is not limited to a speech. As long as sound information becomes useful later, not only a speech but also sound information is stored. An example of the configuration of the seventh exemplary embodiment is described below.

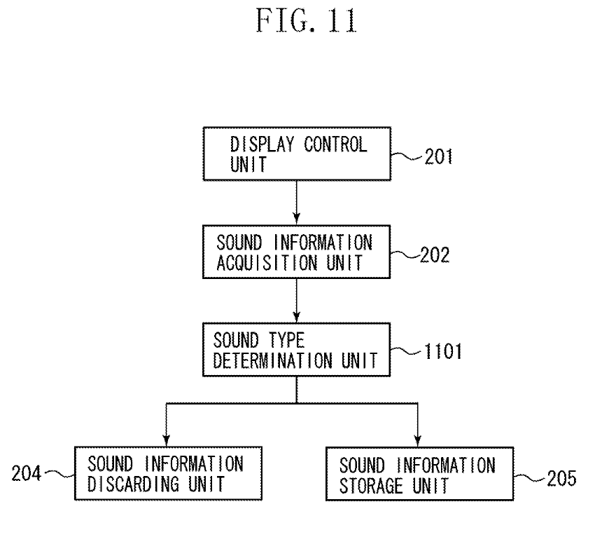

FIG. 11 illustrates a functional configuration of an information processing apparatus according to the seventh exemplary embodiment of the present invention. As illustrated in FIG. 11, the apparatus includes a sound type determination unit 1101 for determining a type of sound information. The sound type determination unit 1101 determines one of groups, into which the input sound information is classified, such that the groups respectively correspond to the types of sounds, such as a speech, a music sound, a natural sound, and a wind noise. Further, in a case where it is determined as a result of the determination that the sound information belongs to a predetermined group corresponding to a predetermined type of a sound, e.g., a speech or a natural sound, the acquired sound information is stored in the sound information storage unit 205 as useful sound information while being related to the currently displayed image data.

On the other hand, in a case where it is determined that the acquired sound information belongs to a group corresponding to the type of a sound, which differs from the predetermined type of a sound, the sound information discarding unit 204 discards the acquired sound information.

A method of determining the type of a sound corresponding to the acquired sound information can be a method of preliminarily generating and storing data representing a Gaussian mixture model (GMM), which corresponds to each type of a sound, and determining which of the GMMs has the highest likelihood to the acquired sound information to thereby determine the type of a sound corresponding to the acquired sound information. However, the method of determining the type of a sound corresponding to the acquired sound information according to the present invention is not limited thereto.

With the above-described configuration, sound information input at the display of image data can be stored while being related to the image data only in a case where the sound corresponding to the acquired sound information is a desired type.

It has been described that the above-described exemplary embodiments start the acquisition of a speech simultaneously with the start of the display of each image data and finish the acquisition of a speech simultaneously with the finish of the display of image data.

However, according to an eighth exemplary embodiment of the present invention, advantages similar to those of the other exemplary embodiments can be obtained even in the case of controlling the apparatus such that each of the start and the finish of acquisition of a speech is delayed by a predetermined time from an associated one of the start and the finish of display of image data.

Each of the above-described exemplary embodiments can be widely applied according to an idea that the start and the finish of acquisition of a speech are performed in consideration of a start timing and a finish timing of display of image data.

In each of the above-described exemplary embodiments, an operation of storing, mainly in a case where one image is displayed, sound information while being related to image data corresponding to the currently displayed image has been described.

However, in a case where there are a large number of images to each of which sound information is related, it is effective that sound information corresponding to each of the images can be recorded at “the time of sequentially displaying the plurality of images while a currently displayed image is serially changed”, e.g., the time of performing what is called a slide show.

In a ninth exemplary embodiment of the present invention, there is described a technique for effectively recording sound information and attaching the sound information to image data while displaying a plurality of images respectively corresponding to the image data in a case where there are a plurality of pieces of image data (i.e., image data to which a speech or useful sound information should be attached) to be used as processing candidates.

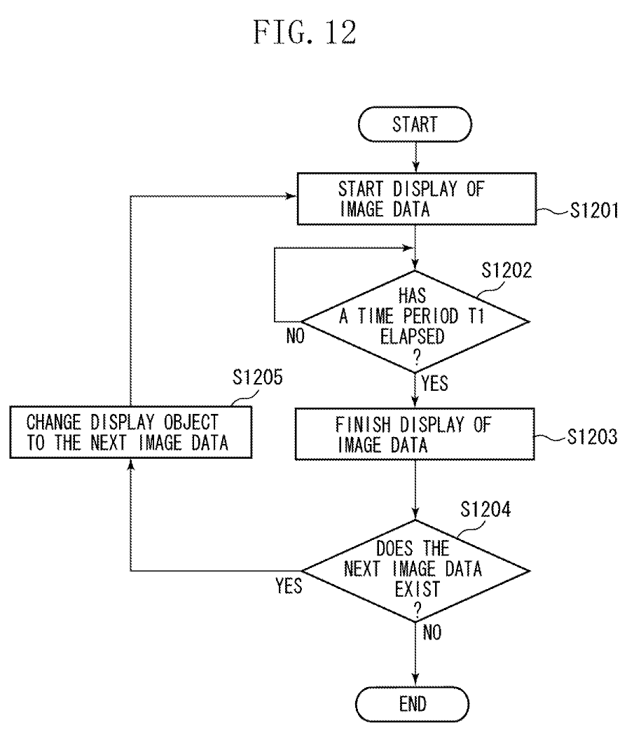

FIG. 12 illustrates steps of a process of displaying each image in a slide show according to the ninth exemplary embodiment of the present invention.

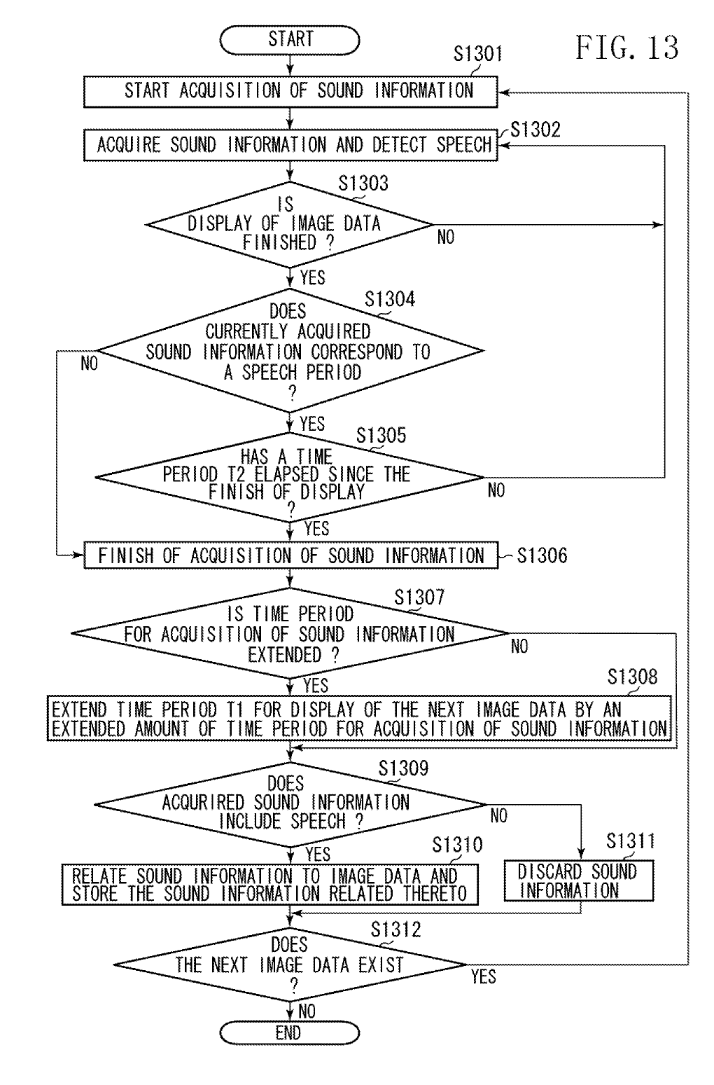

Further, FIG. 13 illustrates steps of a process of storing sound information while relating the sound information to image data, which corresponds to an image to be displayed, in synchronization with a step of starting the display of the image illustrated in FIG. 12 according to the ninth exemplary embodiment of the present invention.

Incidentally, the apparatus, to which the present embodiment is applied, includes at least processing units illustrated in FIG. 1. Further, the apparatus has each of the functions illustrated in FIG. 7. Hereinafter, processing steps illustrated in FIGS. 12 and 13 are described by referring also to FIGS. 1 and 7.

A flow of a process of displaying each image is described below with reference to FIG. 12.

In step S1201 illustrated in FIG. 12, the display control unit 201 causes the display unit 104 illustrated in FIG. 1 to display an image corresponding to image data to be processed.

In step S1202, the display control unit 201 causes the display unit 104 to continue to display the image until it is determined that a time period T1 has elapsed. After the time period T1 has elapsed (YES in step S1202), the process proceeds to step S1203. In step S1203, the display control unit 201 causes the display unit 104 to finish the display of the image.

In step S1204, the display control unit 201 determines whether image data to be processed next is present. If image data to be processed next is present (YES in step S1204), the process proceeds to step S1205. In step S1205, the display control unit 201 sets the next image data as image data to be processed. Then, the process returns to step S1201. If there is no image data to be processed next (NO in step S1204), the process ends.

A flow of a process of acquiring and storing sound information is described below with reference to FIG. 13.

Processing in step S1301 is performed in synchronization with the above-described processing performed in step S1201. A time point at which the display of the image is started in the above-described step S1201 corresponds to a time point at which processing is performed in step S1301. In step S1301, the acquisition of sound information is started by the sound information acquisition unit 202.

In step S1302, the detection of a speech is performed by the speech detection unit 203 on sound information acquired by the sound information acquisition unit 202.

Incidentally, in a routine including steps S1302 to S1305, a time period in which an operation of detecting a speech to be attached to image data corresponding to one image currently displayed is performed is controlled. According to the present embodiment, the process includes various determination steps, such as steps S1303, S1304, and S1305, in order to set an appropriate time period in which the speech detection operation is performed.

Processing in step S1303 is performed in synchronization with the above-described processing performed in step S1203. In step S1303, the display control unit 201 determines whether the display of an image corresponding to sound information, which is currently acquired, is finished.

If the display of the image is not finished (NO in step S1303), the process returns to step S1302. On the other hand, if the display of the image is finished (YES instep S1303), the process proceeds to step S1304. Incidentally, the determination of whether the display of the image is finished can be interpreted as an operation of changing an object, which is displayed, from the image to the next image.

In step S1304, the speech detection unit 203 determines whether sound information currently acquired corresponds to a speech period.

If the sound information currently acquired does not correspond to a speech period (NO in step S1304), then in step S1306, the sound information acquisition unit 202 finishes the acquisition of sound information. On the other hand, if the sound information currently acquired corresponds to a speech period (YES in step S1304), the process proceeds to step S1305. In step S1305, the display control unit 201 determines whether a time period T2 has elapsed since the finish of the display of an image corresponding to sound information. Incidentally, the time period T2 is a preset time period.

If the time period T2 has not elapsed (NO in step S1305), the process returns to step S1302. On the other hand, if the time period T2 has elapsed (YES in step S1305), then in step S1306, the sound information acquisition unit 202 finishes the acquisition of sound information.

As is understood from the foregoing description, the time period T2 is a maximum extension time period in which a speech can be acquired in terms of a speech period corresponding to a certain image.

Incidentally, the sound information acquisition unit 202 preliminarily holds extension information according to which it is determined whether an operation of acquiring a speech is extended. Further, when the process returns to step S1302 from step S1305, extension information indicating that an operation of acquiring a speech is not extended is changed to extension information indicating that an operation of acquiring a speech is extended.

If the sound information acquisition unit 202 finishes the acquisition of sound information through step S1304 or S1305, the process proceeds to step S1307. In step S1307, the sound information acquisition unit 202 determines, based on the above-described extension information, whether the acquisition of sound information is extended.

If the acquisition of sound information is extended (YES in step S1307), then in step S1308, the display control unit 201 extends a time period T1, in which the next image is displayed in step S1202, by the extension time period.

For example, if the time period for acquiring a speech to be attached to the above-described image is extended by a time period T2, the display control unit 201 sets a time period for displaying the next image at T1+T2.

This is performed in consideration of the fact that the next image has been displayed in a time period (i.e., a time period, in which a user's attention is directed to the input of a speech and is not visually directed to the image), by which the acquisition of sound information is extended. That is, this has an advantage in extending a time period, in which a user intentionally checks the next image, substantially to the time period T1. This control operation will be described below.

If the acquisition of sound information is not extended (NO in step S1307), the process proceeds to step S1309.

In step S1309, it is determined based on the acquired sound information whether the speech detection unit 203 detects a speech. If the speech detection unit 203 detects a speech (YES in step S1309), then in step S1310, the sound information storage unit 205 stores sound information while relating the sound information to the image data. If the speech detection unit 203 does not detect a speech (NO in step S1309), then in step S1311, the sound information discarding unit 204 discards sound information.

In step S1312, the display control unit 201 determines whether there is the next image to be displayed (i.e., image data to be processed next). If there is the next image to be displayed (YES in step S1312), the process returns to step S1301, in which the sound information acquisition unit 202 starts the acquisition of sound information corresponding to the image in synchronization with the display of the next image. If there is not the next image (NO in step S1312), the sound information acquisition unit 202 finishes the acquisition of sound information.

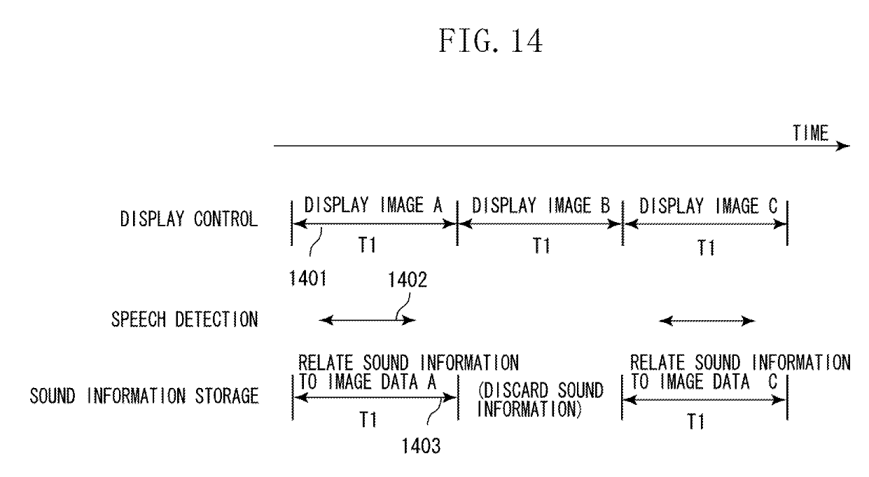

FIGS. 14 through 17 illustrate timings of displaying a plurality of images, those of acquiring sound information (i.e., detecting speeches) corresponding to the plurality of images, and those of storing sound information (i.e., speeches) according to the ninth exemplary embodiment of the present invention. In each of FIGS. 14 through 17, an abscissa axis is a time axis.

FIG. 14 illustrates a case where a time period for acquisition of sound information (i.e., detection of a speech) corresponding to one image falls within a time period in which the one image is displayed.

As illustrated in FIG. 14, a period 1402 for detecting a speech from sound information falls within a period 1401 for displaying an image. In a period 1403, sound information is stored while being related to image data. Incidentally, image data A represents an image A. Image data B represents an image B. Image data C represents an image C.

The display control unit 201 displays the images A, B, and C sequentially in this order for the time period T1 corresponding to each of the images A, B, and C. Further, the sound information acquisition unit 202 acquires sound information corresponding to each of the images A, B, and C in synchronization with the display of the associated image A, B, or C. Then, the speech detection unit 203 detects a speech included in the sound information.

As illustrated in FIG. 14, a speech period corresponding to the image A falls within a period for displaying the image A. In such a case, the process proceeds to step S1306 illustrated in FIG. 13 just after transition from step S1305 to step S1304 is performed. Thus, an operation of extending the acquisition of a speech does not occur. Consequently, the sound information storage unit 205 stores a speech acquired in the period for displaying the image A while relating the acquired speech to the image data A.

As illustrated in FIG. 14, the speech detection unit 203 detects no speech in a period for displaying the image B. In this case, the sound information discarding unit 204 discards sound information (including no speech) acquired in the period for displaying the image B. Accordingly, no speech is attached to the image data B.

As illustrated in FIG. 14, a speech period corresponding to the image C falls within a period for displaying the image C. Consequently, similarly to the case of the image data A, the sound information storage unit 205 stores a speech acquired in the period for displaying the image C while relating the acquired speech to the image data C.

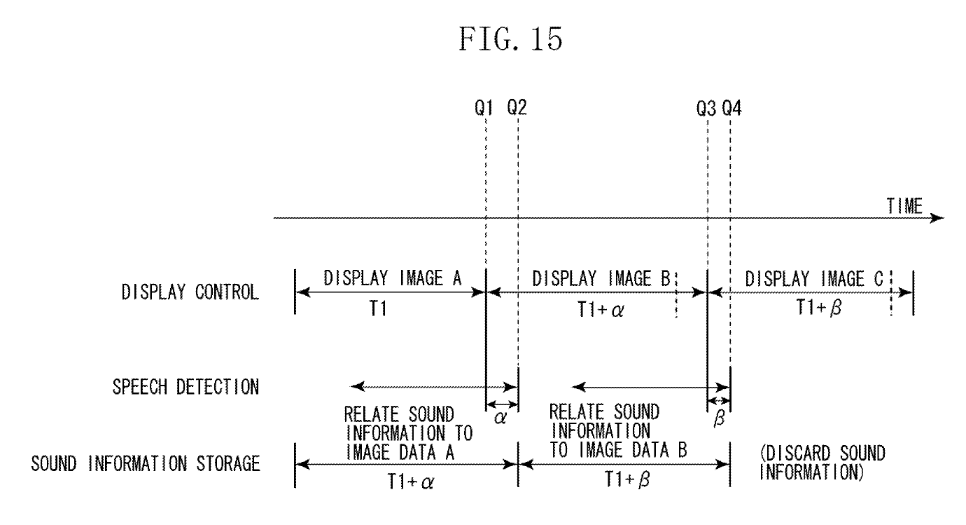

FIG. 15 illustrates a case where a time period of acquisition of sound information (i.e., detection of a speech) corresponding to one image does not fall within a time period in which the one image is displayed. In this case, as illustrated in FIG. 15, a speech period corresponding to a speech detected in a time period, in which an image A is displayed, straddles a time at which the display unit starts to display an image B.

As illustrated in FIG. 15, a first image (image A), and a second image (image B) are sequentially displayed in this order. In a case where a speech is detected at first time point Q1, at which an object to be displayed is changed from the first image to the second image, sound information acquired from the first time point Q1 to second time point Q2 is also stored while being related to the first image data. This operation is described below in detail.

As illustrated in a time period α is an extension period, in which the speech detection unit 203 continues to detect a speech, exceeding the time point Q1, at which the display of the image A is finished.

Similarly, a time period β is an extension period, in which the speech detection unit 203 continues to detect a speech, exceeding the time point Q1, at which the display of the image A is finished. In such a case, after the transition from step S1305 to step S1304 illustrated in FIG. 13 described above, an operation of returning to step S1302 through step S1305 is repeated for the time period α or β.

Additionally, each of the time periods α and β is set to be shorter than the longest extension time period T2, because the determination is made in the determination step S1305.

As illustrated in FIG. 15, a speech detection period corresponding to the image data A is extended by the time period α. Thus, a speech included in sound information acquired in a time period (T1+α) is related and attached to the image data A.

Meanwhile, the display of the image B has been started at the time point at which the display of the image A is finished. However, it is difficult for a user to draw attention to the image B in the above-described extension time period α between the time points Q1 and Q2.

Accordingly, it is necessary to set a time period, in which a user intentionally checks the image B, to be substantially equal to the time period T1. Thus, in the case illustrated in FIG. 15, the time period, in which the image B is displayed, is extended to that (T1+α), because the processing in step S1308 illustrated in FIG. 13 described above should be performed. That is, in a case where a speech corresponding to the image A is present up to the time point Q2, as illustrated in FIG. 15, the display of the image B is extended to time point Q3.

Next, attachment of a speech corresponding to the image B to the image data B is described below. As illustrated in FIG. 15, a speech is detected while the image B is displayed. However, this speech continues to be detected for the time period β even after the display of the image B is finished (i.e., even after the display of the image C is started). That is, the detection of a speech corresponding to the image B is extended to time point Q4.

Then, in this case, a speech included in the sound information acquired in a time period between the time points Q2 and Q4 is attached to the image data B.

Next, a method of controlling the attachment of a speech corresponding to the image C is described below. A speech is detected in a period between the time points Q3 and Q4 in a time period in which the image C is displayed. However, this speech corresponds to the image B and is attached to the image data B.

Accordingly, there is no speech corresponding to the image C. That is, sound information (including no speech) acquired in a time period between the time point Q4 and a time point at which the display of the image C is finished is discarded.

In the foregoing description of the present embodiment, it is assumed that a speech to be attached to the image data B representing the image B illustrated in FIG. 15 is the speech acquired in the time period between the time points Q2 and Q4. However, the present embodiment can be modified as follows. That is, a speech acquired in the time period between the time points Q1 and Q4 is attached to the image data B corresponding to the image B.

In this case, the speech detected in the time period between the time points Q1 and Q2 is redundantly attached to both of the image data A and the image data B. Consequently, e.g., in a case where the image data A and the image data B are individually used, the speech related to both of image data A and the image data B can be fully utilized.

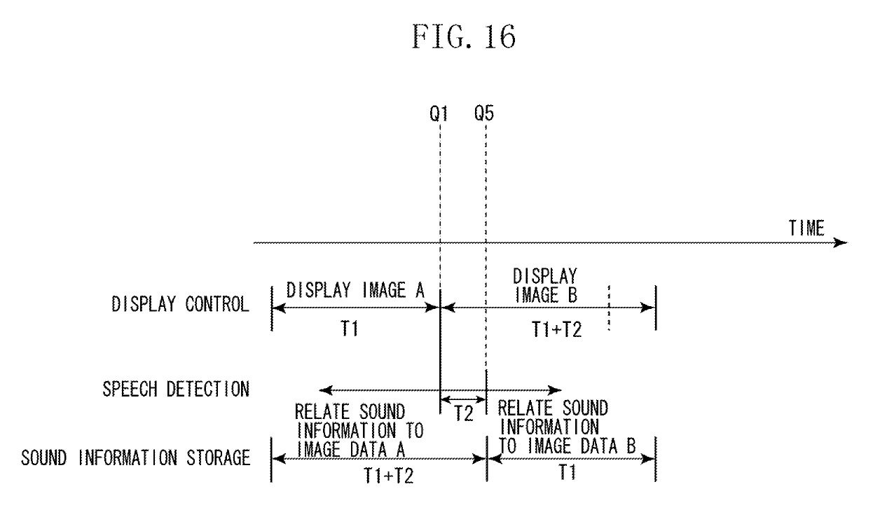

FIG. 16 illustrates a case where a time period of detection of a speech corresponding to an image A exceeds and further continues from a time (i.e., time point Q1) at which a preset time period T2 has elapsed since the finish of display of the image A.

This corresponds to a case where the process proceeds to step S1306 based on the determination made in step S1305 illustrated in FIG. 13 described above, which indicates that the time period T2 has elapsed. That is, in this case, the time period, in which the speech to be attached to the image data A is detected, goes up to the maximum extension time. Thus, the speech included in the sound information acquired in the time period (T1+T2) is attached to the image data A. Then, the process ends.

Immediately subsequent to this, the detection of a speech to be attached to the image data B is started. This switching operation corresponds to a process in which the processing corresponding to the image data B is started from step S1301 illustrated in FIG. 13 just after the process is returned from step S1302 to step S1305, in which processing corresponding to the image A is performed.

Further, in this case, the finish of the acquisition of sound information (including a speech) corresponding to the image A is extended to time point Q5. Thus, the time period, in which the image B is displayed, is extended. The display of the image B illustrated in FIG. 16 is extended by the time period T2.

Thus, a speech acquired in a time period from the time point Q1, at which the display of the image B is started, is related and attached to the image data A. A speech acquired in a time period from the time point Q5 to the finish of the display of the image B is attached to the image data B.

Such a control operation is effective in a case where an upper limit to the speech data at the attachment of a speech to one image is present as a restriction to an apparatus for performing such a control operation, or where a pause in a speech uttered by a user is difficult to determine.

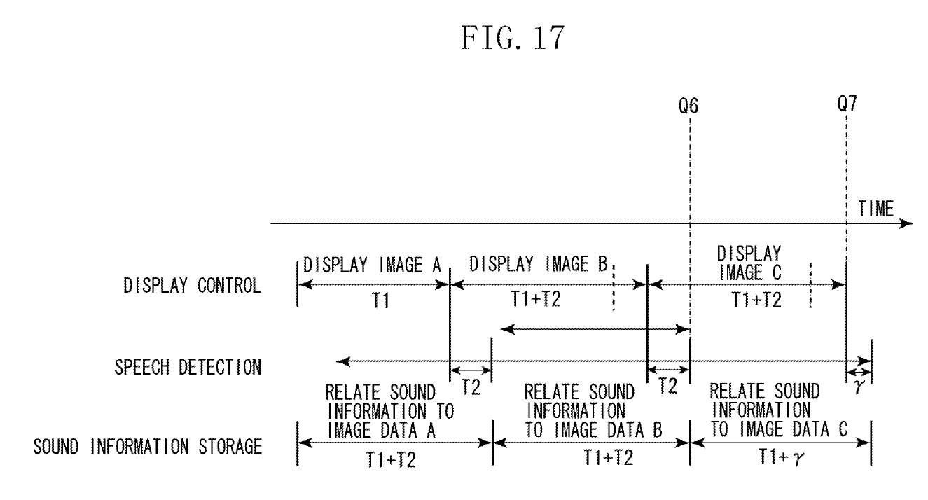

FIG. 17 illustrates a case where a duration of a speech detected in a time period, in which an image A is displayed, exceeds a time period, in which an image B is displayed, and further continues to a time period in which an image C is displayed. In this case, as illustrated in FIG. 17, a speech continues by a time period γ (γ<T2) even after the display unit finishes to display the image C.

In this case, similarly to the process illustrated in FIG. 16, a speech period is once paused at a time point, at which the detection of a speech is extended from the finish of each of the images A and B by the time period T2. Then, a speech included in sound information acquired in the time period (T1+T2) is related and attached to each of the image data A and the image data B.

Further, in the case illustrated in FIG. 17, the time period, in which each of the image B and the image C is displayed, is extended to the time period (T1+T2). Further, a speech included in sound information acquired in the time period between the time points Q6 and Q7 is related and attached to the image data C.

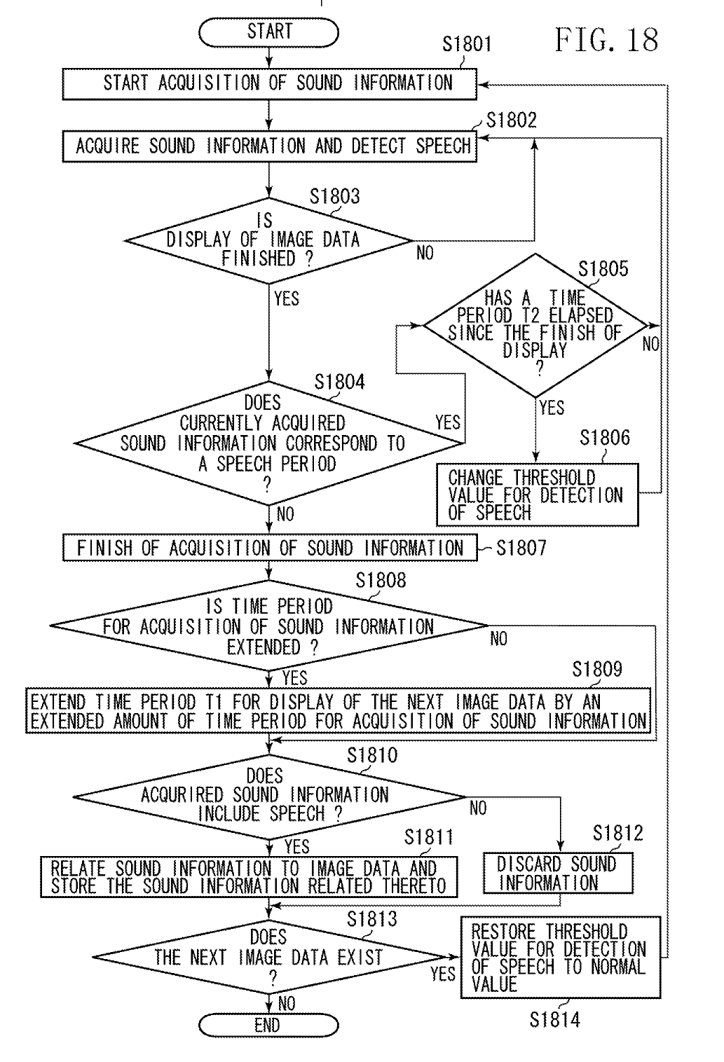

As described above, when the time period T2 elapses since the finish of the display of the image A, the acquisition of sound information corresponding to the image A is forcibly finished. However, a modification of the present embodiment, which performs a control operation equivalent to such an operation of forcibly finishing the acquisition of sound information, is described below with reference to FIG. 18.

Incidentally, the sound information acquisition operation illustrated in FIG. 13 differs from that illustrated in FIG. 18 only in a part of the control function. Thus, the apparatus according to the present invention can be adapted to have two control functions provided in one unit and to switch between the two control functions according to a situation.

The control function used in the operation illustrated in FIG. 18 is such that a threshold value (or a criterion for determining that the currently acquired sound information includes a speech) for the detection of a speech performed by the speech detection unit 203 is changed in a case where the time period for the detection of a speech exceeds the time period T2 illustrated in FIG. 13.

More specifically, the threshold value is changed to a value at which it is difficult to determine in a step corresponding to step S1304 illustrated in FIG. 13 that a speech continues. Consequently, the process is led to the finish of the detection and the acquisition of a speech in a step corresponding to step S1306.

A process flow illustrated in FIG. 18 is described below while being compared with that illustrated in FIG. 13.

First, an operation performed in steps S1801 through S1803 illustrated in FIG. 18 is similar to that performed in steps S1301 through S1303 illustrated in FIG. 13.

In step S1804, the speech detection unit 203 determines whether currently acquired sound information corresponds to a speech period (i.e., includes a speech). Basically, processing performed in step S1804 is similar to that performed in the above-described step S1304.

If the currently acquired sound information does not correspond to a speech period (NO in step S1804), the process proceeds to step S1807. If the currently acquired sound information corresponds to a speech period (YES in step S1804), the process proceeds to step S1805. In step S1807, the sound information acquisition unit 202 finishes the acquisition of sound information.

Processing performed in steps S1807 through S1813 is similar to that performed in steps S1306 through S1312 illustrated in FIG. 13. Thus, in the process illustrated in FIG. 18, steps S1805 and S1806 are characteristic steps.

In step S1805, it is determined whether the time period T2 has elapsed since the finish of the display of an image. Incidentally, this determination itself is similar to that made in the above-described step S1305. If the time period T2 has elapsed (YES in step S1805), the process proceeds to step S1806. If the time period T2 has not elapsed (NO in step S1805), the process returns to step S1802.

In step S1806, the speech detection unit 203 changes the threshold value serving as a criterion for determination at the detection of a speech. This threshold value is, e.g., a minimum magnitude of a sound, at which the sound can be treated as a speech. This change of the threshold value corresponds to an operation of replacing a default criterion with another criterion, at which a speech is more difficult to detect, as compared with the case of using the default criterion. After the processing in the above-described step S1805 or S1806 is finished, the process returns to step S1802.

However, the above-described threshold value is not limited to the above-described quantity of a sound. Another example of the threshold value can be the number of times (i.e., what is called the number of times of zero-crossing), at which the level of a sequence of sounds intersects a predetermined threshold value. Nevertheless, when the threshold value is changed, a default threshold value with another threshold value, at which a speech is more difficult to detect, as compared with the case of using the default threshold value. However, the changed threshold value is reset to the default threshold value in step S1814 halfway through the step S1813 (YES) at a subsequent stage of the process to step S1801.

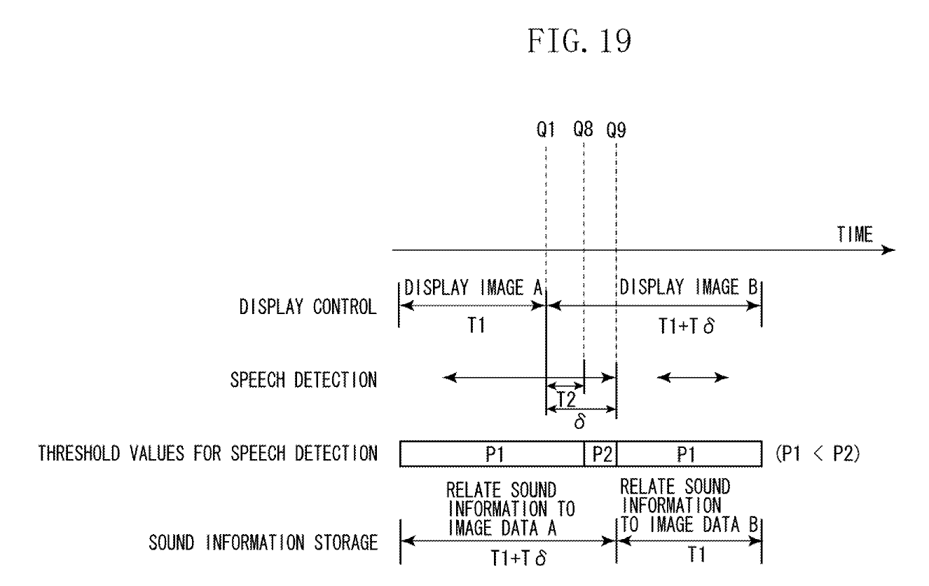

FIG. 19 visually illustrates timings of displaying a plurality of images, those of acquiring sound information corresponding to each of the plurality of images (those of detecting speeches), those of storing sound information (or speeches), similarly to FIGS. 14 to 17. FIG. 19 further illustrates a change in the above-described threshold value for detecting a speech according to the ninth exemplary embodiment of the present invention.

Referring to FIG. 19, a threshold value P1 corresponds to the above-described default threshold value. The threshold value P1 is a minimum magnitude of a sound, at which the sound can be treated as a speech. The threshold value, at which a speech is difficult to detect, corresponds to a threshold value P2. In a case where the threshold values P1 and P2 are of the magnitude of a sound, the values P1 and P2 have the following relationship: P1<P2.

As illustrated in FIG. 19, the speech detection unit 203 detects a speech included in acquired sound information using a normal threshold value P1. That is, the apparatus detects only sounds, the magnitude of each of which exceeds the threshold value P1, as speeches.

As illustrated in FIG. 19, a speech period, which commences while the image A is displayed, is terminated at time point Q9 at which a predetermined time δ has elapsed since the finish of the display of the image A. That is, this speech period still continues even at the time point Q8 at which the time period T2 has elapsed since the finish of the display of the image A.

In the above-described step S1806, the threshold value P1 is changed to the threshold value P2 at time point Q8.

In a time period subsequent to the time point Q8, a speech is detected using the threshold value P2. Thus, the speech period is terminated at the time point Q9, which would be earlier than a time point at which the speech period is terminated using the threshold value P1.

Further, the acquisition of sound information corresponding to the image A is finished at the time point Q9. This finish of the acquisition of sound information corresponds to the transition from step S1804 to step S1807 in a speech acquisition routine for acquiring a speech corresponding to the image A. Incidentally, the time period in which the image B is displayed is extended to a time period T1+δ. This corresponds to the extension performed in step S1809.

A speech included in sound information, which is acquired in the time period T1+δ from the start of the display of the image A, is related and attached to the image data A.

Incidentally, the acquisition of sound information in the time period (T1+δ) is performed since the time point Q9. Then, in the above-described step S1814, the threshold value P2 is reset to the threshold value P1. Subsequently, the detection of a speech corresponding to the image B is performed using the threshold value P1.

Thus, even the method described with reference to FIG. 18 can perform the display of an image and the attachment of a speech to image data representing the image while a speech period corresponding to a speech to be attached to each image is prevented from being excessively extended.

The present invention can also be achieved by providing a storage medium, which stores program code for implementing the operations of the above-described exemplary embodiments, to a system or an apparatus, and by reading and executing the program code stored in the storage medium with the system or the apparatus.

In this case, the program code itself implements the operations of the above-described exemplary embodiments. A computer-readable storage medium, which stores the program code, constitutes the present invention.

For example, a floppy disk, a hard disk, an optical disk, a magneto-optical disc, a compact disc-read-only memory (CD-ROM), a compact disc-recordable (CD-R), a magnetic tape, a nonvolatile memory card, or a ROM can be used as the storage medium.

Further, an operating system (OS) or the like running on a computer can also execute a part or all of actual processing according to instructions generated by the program code and achieve functions of the above-described exemplary embodiments.

Furthermore, after the program code read from a storage medium can be stored in a memory provided in a function expansion board connected to a computer, the function expansion unit can execute a part or all of actual processing to implement the functions of the above-described exemplary embodiments.

According to the above-described exemplary embodiments, sound information can efficiently be acquired in synchronization with displaying of an image on a display unit of a digital camera. In addition, the obtained sound information can efficiently be attached to image data corresponding to the image.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2007-295593 filed Nov. 14, 2007 and No. 2008-228324 filed Sep. 5, 2008, which are hereby incorporated by reference herein in their entirety.

What is claimed is:

1. An information processing apparatus configured to attach sound information to image data while relating the sound information to the image data, the information processing apparatus comprising:
a display control unit configured to cause a display unit to display an image represented by the image data;
an acquisition unit configured to acquire sound information while the display unit is displaying the image;
a detection unit configured to detect whether a speech is included in the sound information acquired by the acquisition unit; and
a storage unit configured to store the sound information while relating the sound information to the image data if the detection unit detects a speech included in the sound information.

2. The information processing apparatus according to claim 1, further comprising a sound information discarding unit configured to discard the sound information if the detection unit does not detect a speech included in the sound information.

3. The information processing apparatus according to claim 1, wherein, if the detection unit detects a speech included in the sound information, the storage unit is configured to store only sound information corresponding to a period in which the speech is detected.

4. The information processing apparatus according to claim 1, further comprising:
a speech recognition unit configured to perform speech recognition on the sound information acquired by the acquisition unit to output one of recognition candidates as a recognition result; and
a recognition result storage unit configured to store the recognition result while relating the recognition result to the image data.

5. The information processing apparatus according to claim 4, further comprising a sound information discarding unit configured to discard the sound information if the speech recognition unit does not output any of the recognition candidates as the recognition result.

6. The information processing apparatus according to claim 1, wherein the display control unit does not finish displaying the image while the detection unit is detecting whether a speech is included in the sound information.

7. The information processing apparatus according to claim 1, further comprising a tilt detection unit configured to detect a state in which the information processing apparatus is tilted,
wherein the display control unit does not finish displaying the image while the tilt detection unit is detecting whether the information processing apparatus has a predetermined tilt in the detected state.

8. The information processing apparatus according to claim 1, wherein the display control unit causes the display unit to sequentially display a first image represented by first image data and a second image represented by second image data, and
wherein, if the detection unit detects a speech at a first time point at which display of the first image is changed to that of the second image, the storage unit stores also sound information acquired by the acquisition unit in a time period from the first time point to a second time point at which no speech is detected by the detection unit.

9. The information processing apparatus according to claim 8, wherein the display control unit extends a time period in which the second image is displayed by the display unit based on the time period from the first time point to the second time point.

10. An information processing apparatus configured to attach sound information to image data while relating the sound information to the image data, the information processing apparatus comprising:
a display control unit configured to cause a display unit to display an image represented by the image data;
an acquisition unit configured to acquire sound information while the display unit is displaying the image;
a sound type determination unit configured to determine a type of the sound information acquired by the acquisition unit; and
a storage unit configured to store the sound information while relating the sound information to the image data if the sound type determination unit determines that the sound information is of a predetermined type.

11. The information processing apparatus according to claim 10, further comprising a sound information discarding unit configured to discard the sound information if the sound type determination unit determines that the type of the sound information differs from the predetermined type.

12. A method for attaching sound information to image data while relating the sound information to the image data, the method comprising:
displaying an image represented by the image data on a display unit;
acquiring sound information while the image is being displayed on the display unit;
detecting whether a speech is included in the acquired sound information; and
if it is detected that a speech is included in the sound information, storing the sound information in a memory while relating the sound information to the image data.

13. A computer-readable storage medium storing a program for causing a computer to perform the method according to claim 12.

14. A method for attaching sound information to image data while relating the sound information to the image data, the method comprising:
displaying an image represented by the image data on a display unit;
acquiring sound information while the image is being displayed on the display unit;
determining a type of the acquired sound information; and
if it is determined that the type of the sound information is a predetermined type, storing the sound information while relating the sound information to the image data.

15. A computer-readable storage medium storing a program for causing a computer to perform the method according to claim 14.
